(19) United States
(12) Patent Application Publication
(10) Pub. No.: US 2019/0235447 A1
(43) Pub. Date: Aug. 1, 2019

(54) ANALOG CLOCK WITH AMBIENT-LIGHT-SENSING DIGITAL FEATURES

(71) Applicant: SHANTEL ANN CONRADI, HERRIMAN, UT (US)

(72) Inventor: SHANTEL ANN CONRADI, HERRIMAN, UT (US)

(21) Appl. No.: 15/884,630

(22) Filed: Jan. 31, 2018

(51) Int. Cl. G04G 9/00; G04B 19/04; G04G 9/10

(52) U.S. Cl. CPC G04G 9/0017; G04G 17/06; G04G 9/10; G04B 19/04

(57) ABSTRACT

A decorative analog clock with an electro-optical sensor configured to control a hidden digital-time display that is only visible when ambient light detected by the electro-optical sensor drops below a threshold.

### CROSS REFERENCE TO RELATED APPLICATIONS

This application claims the priority to U.S. Provisional Patent Application No. 62/452,619, filed Jan. 31, 2017, and entitled “Analog-Hidden Digital Clock,” which is hereby incorporated by reference in its entirety.

### TECHNICAL FIELD

The present disclosure relates generally to time telling devices and clocks, and more particularly to clocks with traditional analog hands as well as digital clock features.

### BACKGROUND

Clocks are traditionally divided into two types, analog and digital. The analog clock has a 12-hour-dial and two hands that move around the clock's surface to indicate hours and minutes. The challenge with traditional analog clocks is that they may be difficult to see in the dark. Digital docks generally have a digit numeric readout showing hours and minutes. The challenge with traditional digital clocks is that they are rarely as ornate as analog clocks. Additionally, traditional digital docks may be difficult to see depending on the luminosity or glare due to the ambient light. Therefore, a need exists for a dock provides the ornate design available with analog clocks that also include features of a digital clock so that the time may be seen in the dark.

### SUMMARY OF THE INVENTION

In view of the foregoing disadvantages inherent in the known art, disclosed herein is a novel solution for an analog-digital clock device. The general purpose of the present invention is to allow a user to use the analog clock features to tell time during the day, and use the digital clock features to tell time at night. The features of the invention that are believed to be novel are distinctly claimed in the concluding portion of the specification.

### BRIEF DESCRIPTION OF THE DRAWINGS

The written disclosure herein describes illustrative embodiments that are non-limiting and non-exhaustive. Reference is made to certain of such illustrative embodiments that are depicted in the figures described below.

FIG. 1 is an isometric view of a clock, according to one embodiment.

FIG. 2 is an isometric view of the rear of the clock, according to one embodiment.

FIG. 3 is an isometric view of a clock showing a digital time display, according to one embodiment.

### DETAILED DESCRIPTION

The present disclosure will be better understood from the detailed description provided below and from the drawings of various embodiments, methods, and examples herein. These specifics, however, are provided for explanatory purposes that help the various embodiments of the disclosure to be better understood. The invention should therefore not be limited by the described embodiments, methods, and examples, but by all embodiments and methods within the scope and spirit of the invention as claimed.

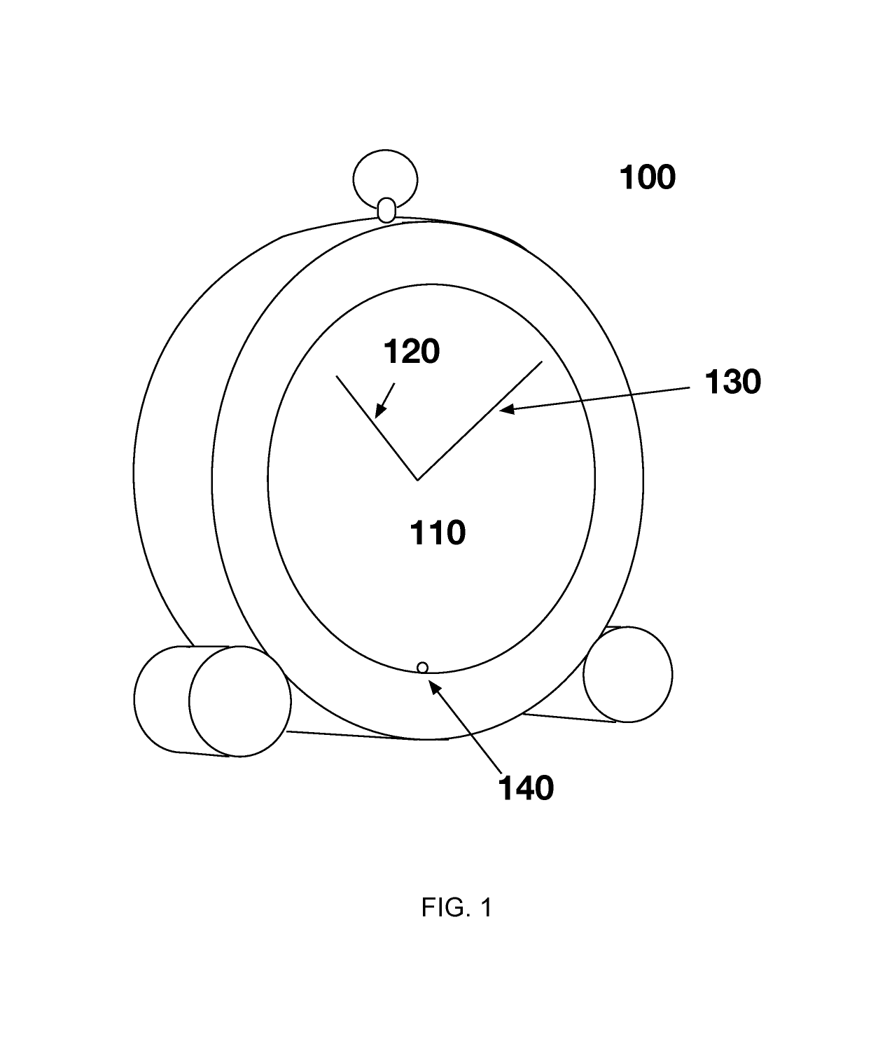

FIG. 1 is an isometric view of a clock 100, according to one embodiment. The clock 100 includes a housing with a face 110, an hour hand 120, and a minute hand 130. In other embodiments, the face 110 may also include a second hand. The clock 100 may also include an electro-optical sensor 140 attached to the housing. The electro-optical sensor 140 may be configured to control a digital-time display having at least four stations for displaying numbers. Specifically, the four stations may provide readings of hours and minutes that correspond to the position of the minute hand 130 and hour hand 120. The electro-optical sensor 140 may detect ambient light levels. When the ambient light levels drop below a threshold, are the only times in which the digital-time display is visible. Otherwise, the digital-time display is hidden when the ambient light levels are above the threshold.

In one embodiment, the digital-time display includes a projected numerical image. The face may include a transparent façade upon which the digital time is displayed. In some embodiments, a light emitting diode lights the digital-time display. In some embodiments, the electro-optical sensor includes one or more photon detectors for providing real-time observation of ambient light.

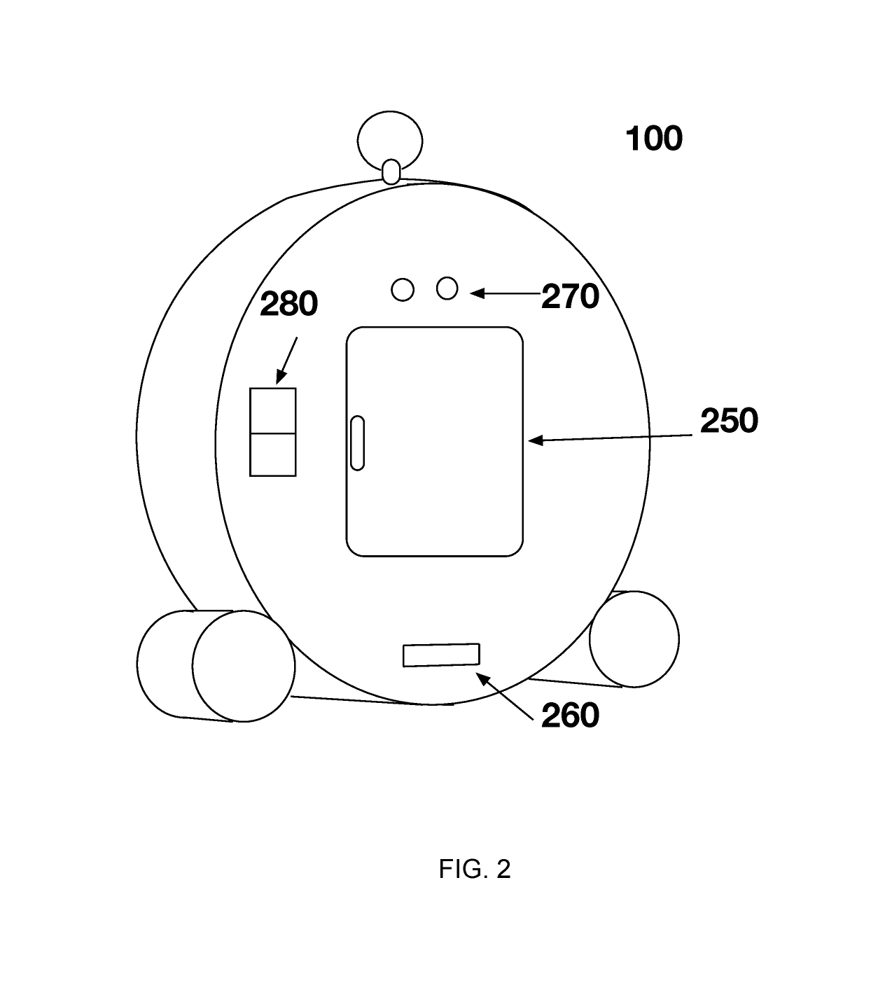

FIG. 2 is an isometric view of the rear of the clock 100, according to one embodiment. The clock may include an internal power supply 250 attached to the housing such as a battery, according to various embodiments. In other embodiments, the clock 100 may include an electrical power cord, wherein the electrical power cord is operatively connected to an external power supply. The clock 100 may include a user interface coupled to the housing, wherein one or more inputs may be programmed into the clock. In one embodiment, the user interface may include one or more Universal Serial Bus (USB) ports 260. The user interface may include one or more knobs and/or buttons 270 for setting one or more alarms, adjusting the time, changing a music selection, increasing or decreasing a sound's volume, and/or altering another input setting. In one embodiment, the user interface may include a touch-screen interface. The user interface may, according to one embodiment, include a dimmer 280 for adjusting the brightness of the digital-time display. In one embodiment, the clock may include a wall mount.

The clock 100 may include one or more speakers coupled to the housing according to various embodiments. The clock 100 may also include a sound memory for storing in digitized form different sounds related to the respective hours of the day that produce an output signal if the ambient light has not dropped below said threshold. The housing may also include a Bluetooth-compatible transceiver positioned substantially within the housing. In one embodiment, the Bluetooth-compatible transceiver is coupled to a pairing switch that is activated by an external communication source. A circuit board having one or more operational characteristics may be positioned substantially within the housing, according to one embodiment.

The clock 100 may include a high-frequency crystal controlled time base, according to one embodiment. The time base may be coupled to a frequency converter in the form of a binary frequency divider that may produce low frequency timing pulses. The timing pulses may control a motor to move the minute hand and the hour hand, according to one embodiment. The clock 100 may also include a settable electronic actuator to produce digital values for concurrently actuating the digital-time display. The digital-time display may be in synchronism with the analog display provided by the minute hand and the hour hand, according to one embodiment.

The clock 100 may also include a microprocessor that includes a data memory for storing the value of one or more selected alarm settings, wherein the microprocessor compares the changing time values corresponding to existing time with the value of the one or more alarm settings to produce an output signal when the changing time values are coincident with the value of the one or more selected alarm settings.

The clock 100 may also include one or more wireless-network-connected-remote-computing devices, wherein the one or more devices receive an input from one or more mobile applications. For instance, in one embodiment the clock may be programmed to synchronize with a calendar application on a mobile phone and automatically set an alarm based on the schedule input into the calendar application. In one embodiment, the clock 100 may be able to synchronize with alarms input into a clock application on a mobile phone such that alarms may be input into the mobile phone directly rather than manually programming the alarms on the user interface. In one embodiment, the clock 100 may include a micro-control unit coupled to the circuit board for receiving remote radio signals. The clock, according to one embodiment, may also include one or more integrated circuits operatively connected to the minute hand and the hour hand as well as the user interface.

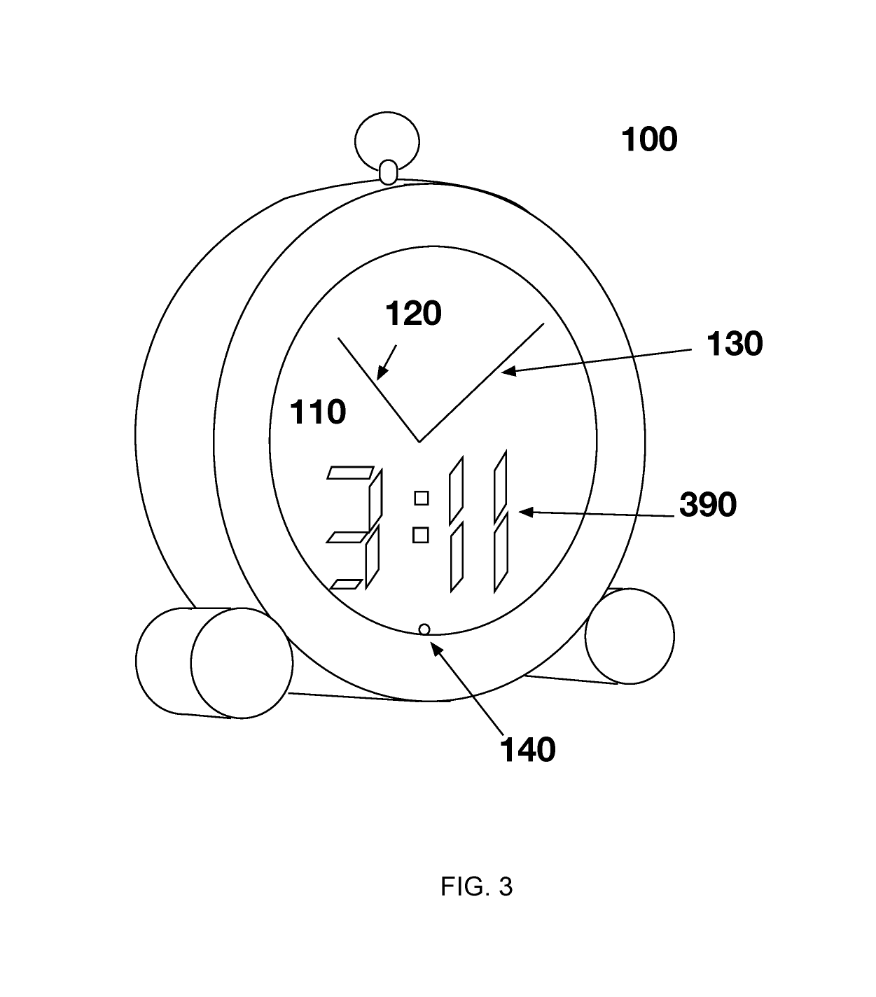

FIG. 3 is an isometric view of a clock 100 showing a digital-time display 390, according to one embodiment. The electro-optical sensor 140 may project a numerical image of the time corresponding to the time shown by the minute hand 130 and the hour hand 120. The digital-time display 390 may be displayed on the face 110 of the clock 100. The digital-time display may be hidden during the daytime and/or when the ambient light is above a threshold, but may appear in response to the ambient light dropping below a threshold.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claim with its dependent claims.

It will be apparent to those having skill in the art that changes may be made to the details of the above-described embodiments without departing from the underlying principles of the invention. Embodiments of the invention in which an exclusive property or privilege is claimed are defined as follows.

What is claimed is:

1. A clock, comprising:
a housing;
at least a minute hand and an hour hand attached to a face of the housing;
an electro-optical sensor attached to the housing and configured to control a digital-time display having at least four stations to provide readings of hours and minutes,
wherein the digital-time display is hidden and only visible when ambient light detected by the electro-optical sensor drops below a threshold;
a Bluetooth-compatible transceiver positioned substantially within the housing;
a circuit board having one or more operational characteristics positioned substantially within the housing;
a user interface coupled to the housing, wherein one or more inputs may be programmed into the clock; and
one or more speakers coupled to the housing.

2. The clock of claim 1, wherein the digital-time display further comprises a projected numerical image.

3. The clock of claim 2, wherein the face further comprises a transparent façade upon which the digital time display is displayed.

4. The clock of claim 1, wherein the digital-time display is lit by a light-emitting diode.

5. The clock of claim 1 further comprising a high-frequency crystal controlled time base.

6. The clock of claim 5 further comprising a frequency converter in the form of a binary frequency divider coupled to said time base to produce low frequency timing pulses wherein said timing pulses control a motor to move the minute hand and the hour hand.

7. The clock of claim 1 further comprising a settable electronic actuator to produce digital values for concurrently actuating the digital-time display to provide digital time indications in synchronism with the analog display provided by the minute hand and the hour hand.

8. The clock of claim 1 further comprising a microprocessor that includes a data memory for storing the value of one or more selected alarm settings, wherein the microprocessor compares the changing time values corresponding to existing time with the value of the one or more alarm settings to produce an output signal when the changing time values are coincident with the value of the one or more selected alarm settings.

9. The clock of claim 1 further comprising a sound memory for storing in digitized form different sounds related to the respective hours of the day that produce an output signal if the ambient light has not dropped below said threshold.

10. The clock of claim 1 further comprising one or more wireless-network-connected-remote-computing devices, wherein the one or more devices receive an input from one or more mobile applications.

11. The clock of claim 1 further comprising a micro-control unit coupled to the circuit board for receiving remote radio signals.

12. The clock of claim 1 further comprising an internal power supply attached to the housing.

13. The clock of claim 1 further comprising an electrical power cord, wherein the electrical power cord is operatively connected to an external power supply.

14. The clock of claim 1, wherein the user interface further comprises one or more Universal Serial Bus ports.

15. The clock of claim 1, wherein the electro-optical sensor further comprises one or more photon detectors for providing real-time observation of ambient light.

16. The clock of claim 1 further comprising a wall mount.

17. The clock of claim 1 wherein the circuit board further comprises one or more integrated circuits operatively connected to the minute hand and the hour hand as well as the user interface.

18. The clock of claim 1, wherein the Bluetooth-compatible transceiver is coupled to a pairing switch that is activated by an external communication source.

19. The clock of claim 1, wherein the user interface further comprises one or more knobs and/or buttons.

20. The clock of claim 1, wherein the user interface is a touch-screen interface.
